(19) United States
(12) Patent Application Publication
(10) Pub. No.: US 2019/0359521 A1
(43) Pub. Date: Nov. 28, 2019

(54) SIZING COMPOSITION FOR MINERAL WOOL BASED ON A HYDROGENATED SUGAR AND INSULATING PRODUCTS OBTAINED

(71) Applicant: SAINT-GOBAIN ISOVER, Courbevoie (FR)

(72) Inventors: Pierre SALOMON, Courbevoie (FR); Marion CHENAL, Montreuil (FR)

(73) Assignee: SAINT-GOBAIN ISOVER, Courbevoie (FR)

(21) Appl. No.: 16/478,745

(22) PCT Filed: Jan. 22, 2018
(86) PCT No.: PCT/FR2018/050149

§ 371 Date: Jul. 17, 2019

(30) Foreign Application Priority Data
Jan. 23, 2017 (FR) 1750514

(51) Int. Cl. C03C 25/321; C03C 13/06; C09J 133/02; C08F 222/02; C08K 3/32; C08K 7/14; C08L 5/00

(52) U.S. Cl. CPC C03C 25/321; C03C 13/06; C09J 133/02; C08K 2003/329; C08K 3/32; C08K 7/14; C08L 5/00; C08F 222/02

(57) ABSTRACT

A process for manufacturing an insulating product based on mineral fibers bonded by an organic binder includes applying an aqueous binding composition to mineral fibers: evaporating a solvent phase of the aqueous binding composition: and thermal curing of the nonvolatile residue of the composition. The aqueous binding composition includes at least one hydrogenated. sugar, at least one polyfunctional crosslinking agent, and hypophosphorous acid. The binding composition is free of reducing sugars or contains at most 10% by weight of reducing sugars.

The present invention relates to the field of thermal and/or acoustic insulating products based on mineral wool, in particular glass or rock wool, and on a formaldehyde-free organic binder.

The invention relates more particularly to a binding composition capable of thermally crosslinking in order to form said organic binder, which is based on at least one hydrogenated sugar, at least one polyfunctional crosslinking agent and hypophosphorous acid, to a process for manufacturing insulating products based on mineral fibers bonded by an organic binder using this binding composition and to the insulating products which result therefrom.

The manufacture of insulating products based on mineral wool generally comprises a step of manufacturing the wool itself, which may be carried out by various processes, for example according to the known technique of fiberizing by internal or external centrifugation.

Internal centrifugation consists in introducing the molten mineral material (glass or rock) into a centrifugal device comprising a multitude of small orifices, the material being projected toward the peripheral wall of the device under the action of the centrifugal force and escaping therefrom in the form of filaments. On leaving the centrifugal device, the filaments are drawn and carried toward a receiving member by a gas stream having a high temperature and a high speed, in order to form a web of fibers (or mineral wool).

External centrifugation consists, for its part, in pouring the molten material at the external peripheral surface of rotary members called rotors, from where the molten material is discharged under the action of the centrifugal force. Means for drawing by means of a gas stream and for collecting on a receiving member are also provided.

In order to ensure assembly of the fibers to one another and to allow the web to have cohesion, a binding composition containing a thermosetting resin is projected onto the fibers, on the path that goes from the outlet of the centrifugal device toward the receiving member. The web of fibers coated with the binding composition is subjected to a heat treatment, at a temperature generally greater than 100° C., in order to carry out the crosslinking of the resin and thus to obtain a thermal and/or acoustic insulating product having specific properties, in particular a dimensional stability, a tensile strength, a recovery of thickness after compression and a uniform color.

The binding composition to be projected onto the mineral wool is generally in the form of an aqueous solution containing the thermosetting resin and additives such as a catalyst for crosslinking the resin, an adhesion-promoting silane, an anti-dusting mineral oil, etc. The binding composition is usually applied to the fibers by spraying.

The properties of the binding composition depend to a large extent on the characteristics of the resin. From the point of view of the application, it is necessary for the binding composition to have a good sprayability and to be able to be deposited at the surface of the fibers in order to efficiently bind them. The resin must be stable during a given period of time before being used to form the binding composition, which composition is generally prepared at the time of use by mixing the resin and the additives mentioned above.

From a regulatory point of view, it is necessary for the resin to be considered non-polluting, that is to say that it contains—and that it generates during the binding step or subsequently—the fewest possible compositions that may be harmful to human health or to the environment.

The thermosetting resins most commonly used are phenolic resins belonging to the resol family. In addition to their good ability to crosslink under the abovementioned thermal conditions, these resins are water-soluble, having a good affinity for mineral fibers, in particular glass fibers, and are relatively inexpensive.

These resols are obtained by condensation of phenol and formaldehyde, in the presence of a basic catalyst, in a formaldehyde/phenol molar ratio of greater than 1, so as to promote the reaction between the phenol and the formaldehyde and to decrease the residual phenol content in the resin.

The condensation reaction between the phenol and the formaldehyde is performed while limiting the degree of condensation of the monomers, in order to avoid the formation of long chains which are not very water-soluble and which reduce dilutability. Consequently, the resin contains a certain proportion of unreacted monomer, in particular the formaldehyde, the presence of which is not desired because of its proven harmful effects.

For this reason, resol-based resins are generally treated with urea which reacts with the free formaldehyde, trapping it in the form of nonvolatile urea-formaldehyde condensates. The presence of urea in the resin also provides a definite economic advantage because of its low cost, since it can be introduced in a relatively large amount without affecting the use qualities of the resin, in particular without harming the mechanical properties of the final product, thereby notably reducing the total cost of the resin.

It has nevertheless been observed that, under the temperature conditions to which the web is subjected in order to obtain crosslinking of the resin, the urea-formaldehyde condensates are not stable; they break down to give again formaldehyde and urea (which is in turn at least partially degraded to ammonia) which are released into the atmosphere of the factory.

The fact that environmental protection regulations are becoming more restrictive means that manufacturers of insulation products must look for solutions that make it possible to further reduce the levels of undesirable emissions, in particular formaldehyde.

Solutions in which the resols are replaced in the binding compositions are known and are based on the use of a polymer of carboxylic acid, in particular of acrylic acid, and of a hydroxylated compound.

In U.S. Pat. No. 5 340 868, the binding composition comprises a polycarboxylic polymer, a β-hydroxylamide and a monomeric carboxylic acid which is at least trifunctional.

Binding compositions have been proposed which comprise a polycarboxylic polymer, a polyol and a catalyst, which catalyst is a catalyst containing phosphorus (U.S. Pat. Nos. 5,318,990, 5,661,213, 6,331,350, US 2003/0008978), a fluoroborate (U.S. Pat. No. 5,977,232) or else a cyanamide, a dicyanamide or a cyanoguanidine (U.S. Pat. No. 5,932,689).

Binding compositions have also been described which comprise an alkanolamine containing at least two hydroxyl groups and a polycarboxylic polymer (U.S. Pat. Nos. 6,071,994, 6,099,773, 6,146,746) combined with a copolymer (U.S. Pat. No. 6,299,936).

In US 2002/0188055, the binding composition comprises a polycarboxylic polymer, a polyol and a cationic, amphoteric or nonionic surfactant.

In US 2004/0002567, the binding composition contains a polycarboxylic polymer, a polyol and a silane-type coupling agent.

US 2005/0215153 describes a binding composition formed from a prebinder containing a carboxylic acid polymer and from a polyol, and from a dextrin as cobinder.

Other solutions for replacing resols are based on the use of a monomeric polyacid and of a polyol.

WO 2006/120523 describes a binding composition which comprises (a) a poly(vinyl alcohol), (b) a multifunctional crosslinking agent chosen from nonpolymeric polyacids or salts thereof, anhydrides or a nonpolymeric polyaldehyde, and (c) optionally a catalyst, the (a):(b) weight ratio ranging from 95:5 to 35:65 and the pH being at least equal to 1.25.

In WO 2008/053332, a binding composition is proposed which comprises an adduct (a) of a sugar polymer and (b) of a multifunctional crosslinking agent chosen from monomeric polyacids or salts thereof, and anhydrides, which is obtained under conditions such that the (a):(b) weight ratio ranges from 95:5 to 35:65.

The applicant has proposed binding compositions containing a hydrogenated sugar and a mixture of hydrogenated sugars containing at least 25% by weight of maltitol and a polymeric or nonpolymeric, polyfunctional crosslinking agent, optionally a catalyst (WO 2010/029266 and WO 2013/014399). In these compositions, the preferred catalyst is sodium hypophosphite, sodium phosphite and mixtures of these compositions. However, because of the hygroscopic nature of this type of catalyst, it follows that the insulation products based on mineral wool obtained from the binding compositions containing it have a high tendency to absorb water.

The aim of the present invention is to provide an improved binding composition which makes it possible to obtain insulation products based on mineral wool having a lower water-retention capacity than those described in the abovementioned applications by the applicant.

Another aim is to provide a binding composition which makes it possible to improve the mechanical properties of the insulating products after aging under humid conditions, in particular their tensile strength.

In order to achieve these aims, the present invention provides a binding composition for insulating products based on mineral wool, in particular glass or rock wool, which comprises

at least one hydrogenated sugar,

at least one polyfunctional crosslinking agent, and

hypophosphorous acid,

and which is free of reducing sugars or contains at most 10% by weight of reducing sugars.

The term “hydrogenated sugar” is intended to mean herein all of the products resulting from the reduction, in any way whatsoever, of a sugar chosen from monosaccharides, oligosaccharides and polysaccharides which are linear, cyclic or branched, and mixtures of these products, in particular starch hydrolysates.

The starch hydrolysates which can be used to obtain the mixture of hydrogenated sugars in accordance with the invention are obtained in a manner known per se, for example by enzymatic and/or acid hydrolysis of one or more starches. The degree of hydrolysis of the starch is generally characterized by the dextrose equivalent (DE), defined by the following relationship:

$$DE = 100 \times ( \frac{number of glycosidic bonds broken}{number of glycosidic bonds in the initial starch} )$$

The DE of starch hydrolysates varies according to the method of hydrolysis used (type of enzyme(s) for example) and the degree of hydrolysis: the distribution of products having various degrees of polymerization can vary to a large extent.

The preferred starch hydrolysates have a DE of between 5 and 99, and advantageously between 10 and 80.

The hydrogenation of the sugar as defined above can be carried out by known methods performed under high hydrogen pressure and high temperature pressure conditions, in the presence of a catalyst chosen from groups IB, IIB, IVB, VI, VII and VIII of the periodic table of elements, preferably from the group comprising nickel, platinum, palladium, cobalt and molybdenum, and mixtures thereof. The preferred catalyst is Raney nickel. The hydrogenation converts the sugar or the mixture of sugars (starch hydrolysate) to corresponding polyols.

Although not preferred, the hydrogenation can be carried out in the absence of hydrogenation catalyst, in the presence of a hydrogen source other than hydrogen gas, for example an alkali metal borohydride such as sodium borohydride.

By way of examples of hydrogenated sugars, mention may be made of erythritol, arabitol, xylitol, sorbitol, mannitol, iditol, maltitol, isomaltitol, lactitol, cellobitol, palatinitol, maltotritol and the hydrogenation products of starch hydrolysates, in particular sold by the company Roquette under the name Polysorb®.

The hydrogenated sugar in accordance with the invention has a number-average molar mass of less than 100 000 g/mol, preferably less than 50 000 g/mol, advantageously less than 5000 g/mol, even better still greater than 180 g/mol.

The hydrogenated sugar in accordance with the invention can contain reducing sugars in a low proportion which does not exceed 5% by weight of solids, preferably 1% and even better still 0.5%. The hydrogenated sugar does not generally contain reducing sugars.

Preferably, use is made of maltitol and mixtures comprising maltitol and hydrogenation products of starch hydrolysates, the maltitol in said mixtures advantageously being predominant, that is to say representing more than 50% by weight. Maltitol is particularly preferred.

The polyfunctional crosslinking agent is capable of reacting with the hydroxyl groups of the hydrogenated sugar under the effect of heat so as to form ester bonds which result in the production of a polymeric network in the final binder. Said polymeric network makes it possible to establish bonds at the level of the points of juncture of the fibers in the mineral wool.

The polyfunctional crosslinking agent is chosen from polycarboxylic organic acids or salts of these acids, and anhydrides thereof.

The term “polycarboxylic organic acid” is intended to mean an organic acid comprising at least two carboxylic functions, preferably at most 300, advantageously at most 70, and even better still at most 15 carboxylic functions.

The polycarboxylic organic acid may be a nonpolymeric or polymeric acid; it has a number-average molar mass generally of less than or equal to 50 000 g/mol, preferably less than or equal to 10 000 g/mol and advantageously less than or equal to 5000 g/mol.

The nonpolymeric polycarboxylic organic acid is a linear, optionally branched, and saturated or unsaturated acid, a cyclic acid or an aromatic acid.

The nonpolymeric polycarboxylic organic acid may be a dicarboxylic acid, for example oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid and its derivatives, in particular containing at least one boron or chlorine atom, tetrahydrophthalic acid and its derivatives, in particular containing at least one chlorine atom, such as chlorendic acid, isophthalic acid, terephthalic acid, mesaconic acid and citraconic acid; a tricarboxylic acid, for example citric acid, tricarballylic acid, 1,2,4-butanetricarboxylic acid, aconitic acid, hemimellitic acid, trimellitic acid and trimesic acid; or a tetracarboxylic acid, for example 1,2,3,4-butanetetracarboxylic acid and pyromellitic acid.

The binding composition may comprise one or more dicarboxylic, tricarboxylic and/or tetracarboxylic acids.

Preferably, the nonpolymeric polycarboxylic organic acid is citric acid.

By way of example of a polymeric polycarboxylic organic acid, mention may be made of homopolymers of unsaturated carboxylic acid such as (meth)acrylic acid, crotonic acid, isocrotonic acid, maleic acid, cinnamic acid, 2-methylmaleic acid, fumaric acid, itaconic acid, 2-methylitaconic acid and α,β-methyleneglutaric acid, or of a monoester of unsaturated dicarboxylic acid, such as a C₁-C₁₀ alkyl maleate or fumarate; copolymers of unsaturated carboxylic acids, in particular of the abovementioned acids, in particular (meth)acrylic acid/maleic acid copolymers; and copolymers of at least one unsaturated carboxylic acid, in particular of abovementioned unsaturated carboxylic acid, and of at least one vinyl monomer, such as styrene optionally substituted with alkyl, hydroxyl or sulfonyl groups, or with a halogen atom, (meth)acrylonitrile, (meth)acrylamide substituted or not with C₁-C₁₀ alkyl groups, alkyl (meth)acrylates, in particular methyl (meth)acrylate, ethyl (meth)acrylate, n-butyl (meth)acrylate and isobutyl (meth)acrylate, glycidyl (meth)acrylate, butadiene and a vinyl ester, in particular vinyl acetate.

Preferably, the binding composition comprises at least one nonpolymeric polycarboxylic organic acid having a number-average molar mass of less than or equal to 1000 g/mol, preferably less than or equal to 750 g/mol and advantageously less than or equal to 500 g/mol, optionally as a mixture with at least one polymeric organic acid.

The polyfunctional crosslinking agent may be an anhydride, in particular maleic anhydride, succinic anhydride or phthalic anhydride.

The polyfunctional crosslinking agent that is particularly preferred is citric acid.

In the binding composition, the hydrogenated sugar represents 10% to 90% of the weight of the mixture consisting of the hydrogenated sugar and the polyfunctional crosslinking agent, preferably 20% to 85%, advantageously 30% to 80% and even better still 45% to 65%.

The binding composition also comprises hypophosphorous acid which acts as a catalyst for the esterification reaction between the hydrogenated sugar and the polyfunctional crosslinking agent, and contributes to a better adjustment of the temperature at the beginning of crosslinking of the binding composition.

The hypophosphorous acid is introduced into the binding composition in a proportion of from 0.1 part to 10 parts by weight per 100 parts by weight of the hydrogenated sugar and of the polyfunctional crosslinking agent, preferably 1 to 5 parts by weight.

Advantageously, the hypophosphorous acid is used in the form of an aqueous solution at 50% by weight of said acid.

Where appropriate, sodium hypophosphite can be used jointly with the hypophosphorous acid, in a low proportion, in particular at most equal to 3 parts by weight per 100 parts by weight of the hydrogenated sugar and of the polyfunctional crosslinking agent, and advantageously at most 1 part. In general, the binding composition does not contain sodium hypophosphite.

The binding composition is an aqueous composition which preferably has a solids content of between 3% and 30% by weight, preferably from 4% to 20% by weight, the hydrogenated sugar, the polyfunctional crosslinking agent and the hypophosphorous acid representing together at least 70%, preferably at least 80% of the solids of the binding composition.

The binding composition in accordance with the invention may also comprise the conventional additives below in the following proportions calculated on the basis of 100 parts by weight of hydrogenated sugar and of polyfunctional crosslinking agent:
0 to 5 parts of silane, in particular an aminosilane or an epoxysilane,
0 to 20 parts of oil, preferably 4 to 15 parts,
0 to 5 parts of a hydrophobic agent, in particular a silicone,
0 to 20 parts of a polyol other than the hydrogenated sugars, in particular glycerol or a polyglycerol.

The role of the additives is known and briefly summarized: the silane is an agent for coupling between the fibers and the binder, and also acts as an anti-aging agent; the oils are hydrophobic anti-dusting agents.

The preparation of the binding composition is carried out by simply mixing the abovementioned constituents.

When the polyfunctional crosslinking agent is a nonpolymeric polyacid, it may be advantageous to subject the binding composition to a heat treatment so as to react a portion of the hydrogenated sugar with said polyacid. By virtue of this heat treatment, the content of low-molar-mass free polyacids in the binding composition is reduced, which has the effect of limiting the gas emissions generated during the firing of the binding composition in the drying oven. The heat treatment is carried out at a temperature which can range from 40 to 150° C.

The binding composition is intended to be applied to mineral fibers, in particular glass or rock fibers.

Conventionally, the binding composition is projected onto the mineral fibers on leaving the centrifugal device and before collection of said fibers on the receiving member in the form of a web of fibers which is then treated at a temperature which makes possible the crosslinking of the binding composition and the formation of an infusible binder. The crosslinking of the binding composition according to the invention is carried out at a temperature comparable to that of a conventional phenol-formaldehyde resin, at a temperature of greater than or equal to 110° C., preferably greater than or equal to 130° C., and advantageously greater than or equal to 140° C.

The acoustic and/or thermal insulating products obtained from these bound fibers also constitute a subject of the present invention.

These products are generally in the form of a mat or a felt of glass or rock mineral wool, or else of a net of mineral fibers, likewise glass or rock mineral fibers, intended in particular to form a surface coating of said mat or of said felt. These products have a particularly advantageous white color.

In addition, the insulating products exhibit a high resistance to the growth of microorganisms, in particular of molds, which is due to the non-fermentable nature of the hydrogenated sugar.

The examples which follow make it possible to illustrate the invention without however limiting it.

In these examples, the following are measured:

the tensile strength, according to standard ASTM C 686-71T, on a sample cut out by stamping in the insulating product. The sample has the shape of a torus 122 mm long, 46 mm wide, with a radius of curvature of the cut of the outer edge equal to 38 mm and a radius of curvature of the cut of the inner edge equal to 12.5 mm.

The sample is placed between two cylindrical mandrels of a testing machine, one of which is mobile and moves at constant speed. The breaking force F (in Newtons) of the sample is measured and the tensile strength TS, defined by the ratio of the breaking force F to the weight of the sample (in Newtons/gram), is calculated.

The tensile strength is measured immediately after manufacture (TSm), after accelerated aging in an autoclave at a temperature of 105° C. under 100% relative humidity for 15 minutes (TS15) or under the conditions of the “Florida” test, and after aging in a closed storage hangar for 1 month (natural aging).

The “Florida” test is carried out under the following conditions: the product is placed in a climatic chamber and subjected 21 times to the 4 cycles of temperature and relative humidity as defined in the table below, the variations in temperature and in relative humidity being carried out at constant speeds.

| Cycle | Time (hours) | Temperature (° C.) | Relative humidity (%) |
|---|---|---|---|
| 1 | 0 to 1.5 | 25 to 55 | 80 to 95 |
| 2 | 1.5 to 4 | 55 | 95 to 35 |
| 3 | 4 to 6 | 55 | 35 to 20 |
| 4 | 6 to 8 | 55 to 25 | 20 to 80 |

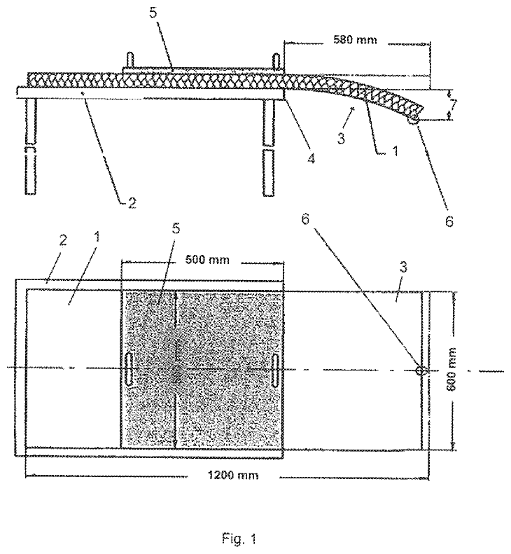

the bending determined according to an internal method of the applicant, set out diagrammatically in FIG. 1, in which the upper part is a sectional view of the appropriate test device and the lower part is a view of this same device from above.

The products tested are in the form of a sample of 1200 mm×600 mm cut from the insulation product. Sample 1 is placed on the upper part of the surface 2 of appropriate size, horizontally, such that an end 3 extends freely beyond the edge of the table 4, by a length of 580 mm. Next, a loading plate 5 is placed on the sample such that the edge of the plate 5 is flush with the edge of the surface 4, the plate having a size of 500 mm×500 mm and a weight of 2765 g corresponding to a load of 0.109 kN/m². Four measurements are carried out on sample 1, at the center 6, on the upper and lower faces. The mean value of the 4 measurements represents the bending 7 (in mm) of the sample. The bending given in tables 1 and 2 is a mean value measured on 4 samples.

the water absorption under the following conditions: 20 to 50 mg of sample (initial weight) are placed in the boat of a balance contained in a climatic chamber maintained at 25° C. and at a relative humidity equal to 75% or 95%. The weight of the sample is measured when the latter is stabilized (final weight). The water absorption (as %) is calculated according to the following formula:

(final weight−initial weight)/initial weight×100

### EXAMPLES 1 TO 3

Binding compositions comprising the constituents shown in table 1, expressed in parts by weight, are prepared.

The binding compositions are prepared by introducing the constituents into a container containing water, with vigorous stirring. The dry extract of the binding compositions is equal to 5% by weight.

The binding compositions are used to form insulation products based on glass wool.

Glass wool is manufactured by the internal centrifugation technique in which the molten glass composition is converted into fibers by means of a tool known as a centrifugation spinner, comprising a basket forming a chamber for receiving the molten composition and a peripheral band pierced by a multitude of orifices: the spinner is rotated about its vertical axis of symmetry, the composition is expelled through the orifices under the effect of the centrifugal force, and the material escaping from the orifices is attenuated into fibers with the help of an attenuating gas flow. The fineness of the glass fibers, measured by the value of their micronaire under the conditions described in patent application FR 2 840 071, is equal to 15.81/min. There is a relationship of correspondence between the micronaire value and the mean diameter of the fibers.

Conventionally, a binding composition spraying ring is placed beneath the fiberizing spinner so as to distribute the binding composition uniformly on the glass wool that has just been formed.

The mineral wool thus bound is collected on a conveyor belt having a width of 2.40 m, equipped with internal suction boxes which retain the mineral wool in the form of a felt or a web at the surface of the conveyor. The conveyor then runs into a drying oven maintained at 240° C., where the constituents of the binding composition polymerize to form a binder. The insulating product obtained has a density equal to 27.0 kg/m³, a thickness of approximately 80 mm immediately after manufacture and a loss on ignition equal to 5.5%.

The properties of the insulation products are given in table 1.

The insulation products manufactured with the binding compositions of examples 1 and 2 according to the invention have better properties than the product of comparative example 3 containing sodium hypophosphite.

The tensile strength is higher in examples 1 and 2 than in comparative example 3, both before aging (TSm) and after aging in an autoclave (TS15) or under the conditions of the “Florida” test.

The bending of the products according to examples 1 and 2, which is lower than that of comparative example 3, corresponds to a greater rigidity of the products.

The water absorption of the products according to examples 1 and 2 is lower than that of comparative example 3, in particular under very high relative humidity conditions (95%).

### EXAMPLES 4 TO 8

These examples are carried out under the conditions described in examples 1 to 3, modified in that the binding compositions contain the constituents described in table 2, in proportions expressed in parts by weight, and in that the glass wool has a micronaire value equal to 17.1 l/min, which corresponds to a higher mean diameter of the glass fibers than in the previous examples.

The tensile strength is higher in examples 5 and 6 than in comparative examples 7 and 8, both before aging (TSm) and after aging in an autoclave (TS15) or natural aging.

TABLE 1

| | | | Ex. 3 | Ex. 4 | Ex. 5 |
|---|---|---|---|---|---|
| | Ex. 1 | Ex. 2 | (comp.) | (comp.) | (comp.) |
| Binding composition | | | | | |
| (parts by weight) | | | | | |
| Maltitol | 48 | 48 | 48 | 24 | 24 |
| Roquette glucose | 0 | 0 | 0 | 31 | 31 |
| syrup 4779 | | | | | |
| Citric acid | 52 | 52 | 52 | 45 | 45 |
| Hypophosphorous acid | 3 | 5 | 0 | 5 | 0 |
| Sodium hypophosphite | 0 | 0 | 5 | 0 | 5 |
| Mineral oil⁽¹⁾ | 7 | 7 | 7 | 7 | 7 |
| Aminosilane⁽²⁾ | 0.5 | 0.5 | 0.5 | 0.5 | 0.5 |
| Silicone⁽³⁾ | 1.5 | 1.5 | 1.5 | 1.5 | 1.5 |
| Tensile strength (N/g) | | | | | |
| Before aging (TSm) | 5.38 | 5.21 | 5.12 | 4.25 | 4.43 |
| After aging | | | | | |
| autoclave (TS15) | 4.21 | 3.93 | 3.60 | 3.54 | 3.42 |
| “Florida test” | 3.93 | 3.65 | 3.38 | 3.46 | 3.36 |
| Bending (mm) | | | | | |
| Initial | 38 | 59 | 56 | — | — |
| After “Florida test” aging | 153 | 162 | 230 | — | — |
| Water absorption (%) | | | | | |
| at 75% relative humidity | 0.86 | 0.93 | 1.09 | — | — |
| at 95% relative humidity | 2.50 | 2.50 | 3.30 | — | — |

⁽¹⁾sold under the reference HW88 by SASOL
⁽²⁾sold under the reference A1100 by MOMENTIVE
⁽³⁾sold under the reference BS5137 by WACKER

The results of table 1 show that replacing the prior art catalyst (sodium hypophosphite) with the catalyst of the invention (hypophosphorous acid) improves the mechanical performances, and in particular the tensile strength before and after aging, only when the binder is essentially based on hydrogenated sugar (maltitol) (see comparison of examples 1 and 2 with comparative example 3). When the binder contains a mixture of hydrogenated sugar and of reducing sugars, replacing the sodium hypophosphite with hypophosphorous acid has no significant effect on the tensile strength of the products obtained (see comparison of comparative examples 4 and 5).

TABLE 2

| | | | | Ex. 9 | Ex. 10 |
|---|---|---|---|---|---|
| | Ex. 6 | Ex. 7 | Ex. 8 | (comp.) | (comp.) |
| Binding composition | | | | | |
| (parts by weight) | | | | | |
| Maltitol | 48 | 48 | 48 | 48 | 48 |
| Citric acid | 52 | 52 | 52 | 52 | 52 |
| Hypophosphorous acid | 1 | 3 | 5 | 0 | 0 |
| Sodium hypophosphite | 0 | 0 | 0 | 5 | 0 |
| Phosphoric acid | 0 | 0 | 0 | 0 | 5.6 |
| Mineral oil⁽¹⁾ | 7 | 7 | 7 | 7 | 7 |
| Aminosilane⁽²⁾ | 0.5 | 0.5 | 0.5 | 0.5 | 0.5 |
| Silicone⁽³⁾ | 1.5 | 1.5 | 1.5 | 1.5 | 1.5 |
| Tensile strength (N/g) | | | | | |
| Before aging (TSm) | 5.80 | 6.08 | 6.21 | 5.37 | 5.50 |
| After autoclave aging (TS15) | 4.38 | 4.44 | 4.72 | 4.02 | 2.72 |
| After natural aging | 4.55 | 4.85 | 5.19 | 4.76 | 4.09 |

⁽¹⁾sold under the reference HW88 by SASOL
⁽²⁾sold under the reference A1100 by MOMENTIVE
⁽³⁾sold under the reference BS5137 by WACKER

The results of table 2 above show that the improvement in the tensile strength of the insulation products depends on the hypophosphorous acid concentration: the higher this concentration, the better the tensile strength of the products (see examples 6, 7 and 8).

1. A process for manufacturing an insulating product based on mineral fibers bonded by an organic binder, comprising:
applying an aqueous binding composition to mineral fibers:
evaporating a solvent phase of the aqueous binding composition; and
thermal curing of the nonvolatile residue of the composition, wherein the aqueous binding composition comprises
at least one hydrogenated sugar,
at least one polyfunctional crosslinking agent, and
hypophosphorous acid,
the binding composition being free of reducing sugars or containing at most 10% by weight of reducing sugars.

2. The process as claimed in claim 1, wherein the hydrogenated sugar is chosen from the hydrogenation products of monosaccharides, oligosaccharides and polysaccharides which are linear, cyclic or branched.

3. The process as claimed in claim 1, wherein the hydrogenated sugar is erythritol, arabitol, xylitol, sorbitol, mannitol, iditol, maltitol, isomaltitol, lactitol, cellobitol, palannitol, maltotritol or the hydrogenation products of starch hydrolysates.

4. The process as claimed in claim 3, wherein the hydrogenated sugar is maltitol, or a mixture comprising maltitol and hydrogenation products of starch hydrolysates, containing more than 50% by weight of maltitol.

5. The process as claimed in claim 1, wherein the binding composition has a solids content of between 3% and 30% by weight, and the hydrogenated sugar, the polyfunctional crosslinking agent and the hypophosphorous acid together representing at least 70% of the solids of the binding composition.

6. The process as claimed in claim 1, wherein the polyfunctional crosslinking agent is chosen from polycarboxylic organic acids or salts of these acids, and anhydrides thereof.

7. The process as claimed in claim 6, wherein the polycarboxylic organic acid comprises at least two carboxylic functions.

8. The process as claimed in claim 7, wherein the polycarboxylic organic acid is chosen from linear, branched and saturated or unsaturated no polymeric polycarboxylic organic acids, cyclic acids and aromatic acids.

9. The process as claimed in claim 8, wherein the polycarboxylic organic acid is chosen from dicarboxylic acids, including oxalic acid, malonic acid, succinic acid, glutaric acid, adipic acid, pimelic acid. suberic acid, a.zelaic acid, sebacic acid, malic acid, tartaric acid, tartronic acid, aspartic acid, glutamic acid, fumaric acid, itaconic acid, maleic acid, traumatic acid, camphoric acid, phthalic acid and its derivatives that contain at least one boron or chlorine atom, tetrahydrophthalic acid and its derivatives that contain at least one chlorine atom, isophthalic acid, terephthalic acid, mesaconic acid and citraconic acid, tricarboxylic acids, including citric acid, tricarballylic acid, 1,2,4-butanetricarboxylic acid, aconitic acid, hemimellitic acid, trimellitic acid and trimesic acid; and tetracarboxylic acids, including 1,2,3,4-butanetetracarboxylic acid and pyromellitic acid.

10. The process as claimed in claim 6, wherein the polycarboxylic organic acid is chosen from polymeric polycarboxylic organic acids, including homopolymers of unsaturated carboxylic acid or of a monoester of unsaturated dicarboxylic acid, copolymers of unsaturated carboxylic acids, and copolymers of at least one unsaturated carboxylic acid and of at least one vinyl monomer.

11. The process as claimed in claim 10, wherein the unsaturated carboxylic acid is eth)acrylic acid, crotonic acid, isocrotonic acid, maleic acid, cinnamic acid, 2-methylmaleic acid, fumaric acid, itaconic acid, 2-methylitaconic acid, α,β-methyleneglutaric acid and monoesters of unsaturated dicarboxylic acids, and the vinyl monomer is styrene optionally substituted with alkyl, hydroxyl or sulfonyl groups, or with a halogen atom, (meth)acrylonitrile, (meth)acrylamide optionally substituted with C₁-C₁₀ alkyl groups, alkyl (meth)acrylates, glycidyl (meth)acrylate, butadiene and a vinyl ester.

12. The process as claimed in claim 1, wherein the hydrogenated sugar represents 10% to 90% of the weight of the mixture consisting of the hydrogenated sugar and the polyfunctional crosslinking agent.

13. The process as claimed in claim 1, wherein the hypophosphorous acid represents 0.1 part to 10 parts by weight per 100 parts by weight of the hydrogenated sugar and of the polyfunctional crosslinking agent.

14. The process as claimed in claim 1, further comprising the additives below in the following proportions calculated on the basis of 100 parts by weight of hydrogenated sugar and of polyfunctional crosslinking agent:
0 to 5 parts of same, including an aminosilane or an epoxysilane,
0 to 20 parts of oil,
0 to 5 parts of a hydrophobic agent, including a silicone,
0 to 20 parts of a polyol other than the hydrogenated sugars, including glycerol or a polyglycerol.

15. (canceled)

16. An insulating product based on mineral fibers bonded by an organic binder, obtained by the process as claimed in claim 1.

17. The process as claimed in claim 1, wherein the mineral wool is rock or glass wool.

18. The process as claimed in claim 1, wherein the binding composition has a solids content of between 4% and 20% by weight, and the hydrogenated sugar, the polyfunctional crosslinking agent and the hypophosphorous acid together representing at least 80% of the solids of the binding composition.

19. The process as claimed in claim 1, wherein the hydrogenated sugar represents 45% to 65% of the weight of the mixture consisting of the hydrogenated sugar and the polyfunctional crosslinking agent.

20. The process as claimed in claim 6, wherein the polycarboxylic organic acid is citric acid.
